(19) United States
(12) Patent Application Publication
(10) Pub. No.: US 2026/0223201 A1
(43) Pub. Date: Jul. 30, 2026

(54) CHANNEL OCCUPANCY TIME SHARING

(71) Applicant: QUALCOMM Incorporated, San Diego, CA (US)

(72) Inventors: Luanxia YANG, Beijing (CN); Jing SUN, San Diego, CA (US); Changlong XU, Beijing (CN); Giovanni CHISCI, San Diego, CA (US); Xiaoxia ZHANG, San Diego, CA (US); Shaozhen GUO, Beijing (CN); Siyi CHEN, Beijing (CN); Hao XU, Beijing (CN)

(21) Appl. No.: 19/146,392

(22) PCT Filed: Mar. 2, 2023
(86) PCT No.: PCT/CN2023/079202

§ 371 Date: Jul. 8, 2025

(51) Int. Cl. H04W 74/08; H04L 27/26

(52) U.S. Cl. CPC H04W 74/0866; H04L 27/2678

(57) ABSTRACT

Various aspects of the present disclosure generally relate to wireless communication. In some aspects, a user equipment (UE) may transmit, to one or more other UEs, a channel occupancy time (COT) sharing indication that indicates a plurality of resource block sets associated with a shared COT. The UE may transmit, using a wideband and based at least in part on a COT sharing condition, within one or more resource block sets of the plurality of resource block sets associated with the shared COT. Numerous other aspects are described.

### FIELD OF THE DISCLOSURE

Aspects of the present disclosure generally relate to wireless communication and to techniques and apparatuses for channel occupancy time sharing.

### BACKGROUND

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and types of wireless communications mediums available for use, and the like. Consequently, there exists a need for further improvements in wireless communications systems to overcome the aforementioned technical challenges and others.

### SUMMARY

One aspect provides a method for wireless communication by a user equipment (UE). The method includes transmitting, to one or more other UEs, a channel occupancy time (COT) sharing indication that indicates a plurality of resource block sets associated with a shared COT; and transmitting, using a wideband and based at least in part on a COT sharing condition, within one or more resource block sets of the plurality of resource block sets associated with the shared COT.

Another aspect provides a method for wireless communication by a network entity. The method includes transmitting, to one or more other UEs, a COT sharing indication that indicates a plurality of resource block sets associated with a shared COT; and transmitting, to the one or more other UEs, COT structure information (COT-SI) at each resource block set of the plurality of resource block sets, the COT-SI transmitted at each resource block set including resource allocation information for the resource block set.

Other aspects provide: an apparatus operable, configured, or otherwise adapted to perform any one or more of the aforementioned methods and/or those described herein with reference to and as illustrated by the drawings and specification; a non-transitory, computer-readable medium comprising computer-executable instructions that, when executed by a processor of an apparatus, cause the apparatus to perform the aforementioned methods and/or those described herein with reference to and as illustrated by the drawings and specification; a computer program product embodied on a computer-readable storage medium comprising code for performing the aforementioned methods and/or those described herein with reference to and as illustrated by the drawings and specification; and/or an apparatus comprising means for performing the aforementioned methods and/or those described herein with reference to and as illustrated by the drawings and specification. By way of example, an apparatus may comprise a processing system, a device with a processing system, or processing systems cooperating over one or more networks.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 depicts an example of a wireless communications network, in accordance with the present disclosure.

FIG. 2 depicts aspects of an example base station and user equipment (UE), in accordance with the present disclosure.

FIG. 3 depicts an example disaggregated base station architecture.

FIGS. 4A, 4B, 4C, and 4D depict aspects of data structures for a wireless communications network, such as wireless communications network of FIG. 1, in accordance with the present disclosure.

FIG. 5 is a diagram illustrating an example of channel occupancy time (COT) resource block (RB) sets, in accordance with the present disclosure.

FIG. 6 is a diagram illustrating an example of COT sharing, in accordance with the present disclosure.

FIGS. 7A-7B are diagrams illustrating examples of RB sets for COT sharing, in accordance with the present disclosure.

FIG. 8 is a diagram illustrating an example of COT sharing, in accordance with the present disclosure.

FIGS. 9A-9C are diagrams illustrating examples of RB sets for COT sharing, in accordance with the present disclosure.

FIG. 10 shows a method for wireless communications by a UE.

FIG. 11 shows a method for wireless communications by a UE.

FIG. 12 is a diagram illustrating an example of an implementation of code and circuitry for a communications device, in accordance with the present disclosure.

FIG. 13 is a diagram illustrating an example of an implementation of code and circuitry for a communications device, in accordance with the present disclosure.

### DETAILED DESCRIPTION

Aspects of the present disclosure provide apparatuses, methods, processing systems, and computer-readable mediums for channel occupancy time (COT) sharing.

A COT initiating user equipment (UE) may initiate a COT across multiple resource block (RB) sets. The COT initiating UE may share the COT with one or more responding UEs. This may enable each of the one or more responding UEs to occupy one or more RB sets within the COT and to perform transmissions using the one or more RB sets within the COT. For example, the COT initiating UE may occupy a first resource within a first RB set, a first resource within a second RB set, and a first resource within a third RB set. A first responding UE may occupy a second resource within the first RB set, a second responding UE may occupy a second resource within the second RB set and a second resource within the third RB set, and a third responding UE may occupy a third resource within the second RB set and a third resource within the third RB set. In some cases, the COT initiating UE may determine to resume transmissions in the shared COT. However, the COT initiating UE may not be able to determine which RB sets the COT initiating UE is permitted to use when resuming the transmissions. For example, the COT initiating UE may not be able to perform a transmission using a fourth resource within the first RB set since the third resource within the first RB set is not occupied by any of the responding UEs. This may result in missed transmission opportunities within the shared COT and/or may result in transmission collisions within the shared COT between the COT initiating UE and the one or more responding UEs.

Techniques and apparatuses are described herein for COT sharing. A COT initiating UE may transmit a COT sharing indication to one or more responding UEs that indicates a plurality of RB sets associated with a shared COT. The one or more responding UEs may perform transmissions within one or more RB sets associated with the shared COT based at least in part on the COT sharing indication. In some aspects, the COT initiating UE may determine to transmit within one or more RB sets of the shared COT using a wideband and based at least in part on a COT sharing condition. In one example, the COT sharing indication may indicate that the COT initiating UE is not permitted to transmit within any of the RB sets of the shared COT. In another example, the COT sharing indication may indicate that the COT initiating UE is permitted to transmit within the RB sets of the shared COT based at least in part on the COT sharing condition being satisfied. The COT sharing condition may indicate, for example, that the COT initiating UE can transmit within the one or more RB sets of the shared COT if the responding UEs occupy all resources within the wideband. In some aspects, the COT initiating UE may transmit COT structure information (COT-SI), in each RB set of the plurality of RB sets, that indicates resource allocation information for the corresponding RB set. In one example, a radio resource control (RRC) message may be used to configure the time and frequency resources for the COT-SI. In another example, the COT-SI may be transmitted using sidelink control information (SCI), such as second stage sidelink control information (SCI-2).

The techniques and apparatuses described herein may enable the COT initiating UE to determine which RB sets the COT initiating UE can use for resuming transmissions within the shared COT. This may reduce missed transmission occasions within the shared COT and may reduce transmission collisions within the shared COT. In the example where the COT sharing indication indicates that the COT initiating UE is not permitted to transmit within any of the RB sets of the shared COT, overlapping transmissions between the COT initiating UE and the responding UEs within the shared COT may be reduced or eliminated. In the example where the COT sharing indication indicates that the COT initiating UE can transmit within the RB sets of the shared COT based at least in part on a COT sharing condition, the COT initiating UE may be permitted to resume transmissions within the shared COT if the COT sharing condition is satisfied, thereby reducing a likelihood of missed transmission occasions within the shared COT. In some examples, the COT initiating UE may transmit COT-SI that explicitly indicates which RB sets within the COT are able to be used for transmissions by respective UEs. This may enable the COT initiating UE and the responding UE to share the COT while reducing or eliminating overlapping transmissions and wasted resources.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

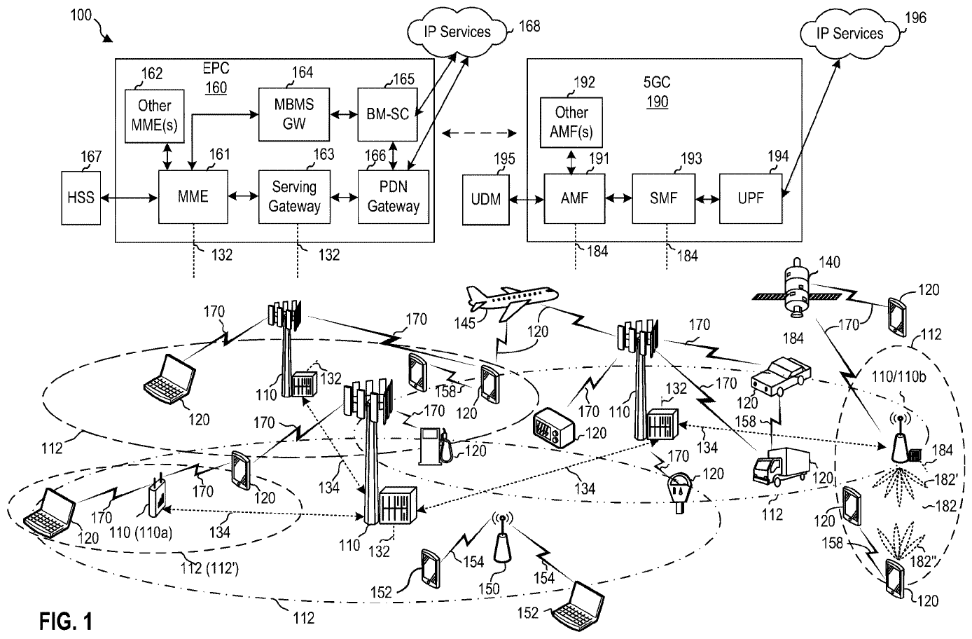

FIG. 1 depicts an example of a wireless communications network 100, in accordance with the present disclosure.

Generally, wireless communications network 100 includes various network entities (alternatively, network elements or network nodes). A network entity is generally a communications device and/or a communications function performed by a communications device (e.g., a UE, a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 110), and non-terrestrial aspects, such as satellite 140 and aircraft 145, which may include network entities on-board (e.g., one or more BSs) capable of communicating with other network elements (e.g., terrestrial BSs) and UEs.

In the depicted example, wireless communications network 100 includes BSs 110, UEs 120, and one or more core networks, such as an Evolved Packet Core (EPC) 160 and 5G Core (5GC) 190, which interoperate to provide communications services over various communications links, including wired and wireless links.

FIG. 1 depicts various example UEs 120, which may include a cellular phone, a smart phone, a session initiation protocol (SIP) phone, a laptop, a personal digital assistant (PDA), a satellite radio, a global positioning system (GPS), a multimedia device, a video device, a digital audio player, a camera, a game console, a tablet, a smart device, a wearable device, a vehicle, an electric meter, a gas pump, a kitchen appliance, a healthcare device, an implant, a sensor/actuator, a display, an internet of things (IoT) device, an always on (AON) device, an edge processing device, or another similar device. A UE 120 may also be referred to as a mobile device, a wireless device, a wireless communication device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, or a handset, among other examples.

BSs 110 may wirelessly communicate with (e.g., transmit signals to or receive signals from) UEs 120 via communications links 170. The communications links 170 between BSs 110 and UEs 120 may carry uplink (UL) (also referred to as reverse link) transmissions from a UE 120 to a BS 110 and/or downlink (DL) (also referred to as forward link) transmissions from a BS 110 to a UE 120. The communications links 170 may use multiple-input and multiple-output (MIMO) antenna technology, including spatial multiplexing, beamforming, and/or transmit diversity in various aspects.

A BS 110 may include, for example, a NodeB, an enhanced NodeB (eNB), a next generation enhanced NodeB (ng-eNB), a next generation NodeB (gNB or gNodeB), an access point, a base transceiver station, a radio base station, a radio transceiver, a transceiver function, a transmission reception point, and/or others. A BS 110 may provide communications coverage for a respective geographic coverage area 112, which may sometimes be referred to as a cell, and which may overlap in some cases (e.g., a small cell provided by a BS 110a may have a coverage area 112′ that overlaps the coverage area 112 of a macro cell). A BS 110 may, for example, provide communications coverage for a macro cell (covering a relatively large geographic area), a pico cell (covering a relatively smaller geographic area, such as a sports stadium), a femto cell (covering a relatively smaller geographic area (e.g., a home)), and/or other types of cells.

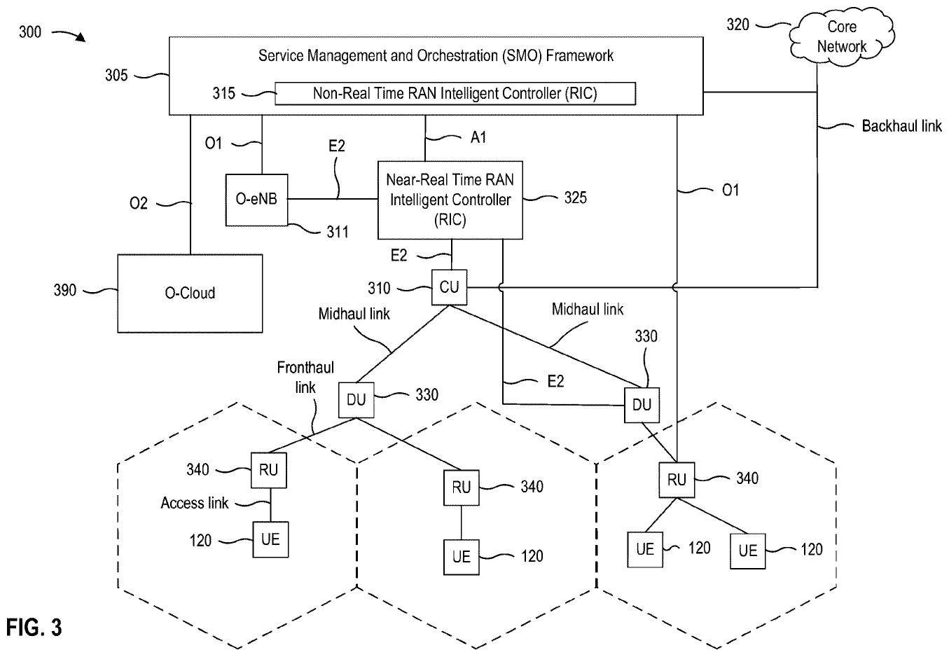

While BSs 110 are depicted in various aspects as unitary communications devices, BSs 110 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a BS (e.g., BS 110) may include components that are located at a single physical location or components located at various physical locations. In examples in which a BS includes components that are located at various physical locations, the various components may each perform functions such that, collectively, the various components achieve functionality that is similar to a BS that is located at a single physical location. In some aspects, a BS including components that are located at various physical locations may be referred to as having a disaggregated radio access network architecture, such as an Open RAN (O-RAN) architecture or a Virtualized RAN (VRAN) architecture. FIG. 3 depicts and describes an example disaggregated BS architecture.

Different BSs 110 within wireless communications network 100 may also be configured to support different radio access technologies, such as 3G, 4G, and/or 5G, among other examples. For example, BSs 110 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 110 configured for 5G (e.g., 5G NR or Next Generation RAN (NG-RAN)) may interface with 5GC 190 through second backhaul links 184. BSs 110 may communicate directly or indirectly (e.g., through the EPC 160 or 5GC 190) with each other over third backhaul links 134 (e.g., X2 interfaces), which may be wired or wireless.

Wireless communications network 100 may subdivide the electromagnetic spectrum into various classes, bands, channels, or other features. In some aspects, the subdivision is based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-52,600 MHz, which is sometimes referred to (interchangeably) as a “millimeter wave” (“mmW” or “mmWave”). A base station configured to communicate using mmWave or near mmWave radio frequency bands (e.g., a mmWave base station such as BS 110b) may utilize beamforming (e.g., as shown by 182) with a UE (e.g., 120) to improve path loss and range.

The communications links 170 between BSs 110 and, for example, UEs 120, may be through one or more carriers, which may have different bandwidths (e.g., 5 MHz, 10 MHz, 15 MHz, 20 MHz, 100 MHz, 400 MHz, and/or other bandwidths), and which may be aggregated in various aspects. Carriers may or may not be adjacent to each other. In some examples, allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., base station 110b in FIG. 1) may utilize beamforming with a UE 120 to improve path loss and range, as shown at 182. For example, BS 110b and the UE 120 may each include a plurality of antennas, such as antenna elements, antenna panels, and/or antenna arrays to facilitate the beamforming. In some cases, BS 110b may transmit a beamformed signal to UE 120 in one or more transmit directions 182′. UE 120 may receive the beamformed signal from the BS 110b in one or more receive directions 182″. UE 120 may also transmit a beamformed signal to the BS 110b in one or more transmit directions 182″. BS 110b may also receive the beamformed signal from UE 120 in one or more receive directions 182′. BS 110b and UE 120 may then perform beam training to determine the best receive and transmit directions for each of BS 110b and UE 120. Notably, the transmit and receive directions for BS 110b may or may not be the same. Similarly, the transmit and receive directions for UE 120 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 120 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 161, other MMEs 162, a Serving Gateway 163, a Multimedia Broadcast Multicast Service (MBMS) Gateway 164, a Broadcast Multicast Service Center (BM-SC) 165, and/or a Packet Data Network (PDN) Gateway 166, such as in the depicted example. MME 161 may be in communication with a Home Subscriber Server (HSS) 167. MME 161 is a control node that processes the signaling between the UEs 120 and the EPC 160. Generally, MME 161 provides bearer and connection management.

Generally, user Internet protocol (IP) packets are transferred through Serving Gateway 163, which is connected to PDN Gateway 166. PDN Gateway 166 provides UE IP address allocation as well as other functions. PDN Gateway 166 and the BM-SC 165 are connected to IP Services 168, which may include, for example, the Internet, an intranet, an IP Multimedia Subsystem (IMS), a Packet Switched (PS) streaming service, and/or other IP services.

BM-SC 165 may provide functions for MBMS user service provisioning and delivery. BM-SC 165 may serve as an entry point for content provider MBMS transmission, may be used to authorize and initiate MBMS Bearer Services within a public land mobile network (PLMN), and/or may be used to schedule MBMS transmissions. MBMS Gateway 164 may distribute MBMS traffic to the BSs 110 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 191, other AMFs 192, a Session Management Function (SMF) 193, and a User Plane Function (UPF) 194. AMF 191 may be in communication with Unified Data Management (UDM) 195.

AMF 191 is a control node that processes signaling between UEs 120 and 5GC 190. AMF 191 provides, for example, quality of service (QoS) flow and session management.

IP packets are transferred through UPF 194, which is connected to the IP Services 196, and which provides UE IP address allocation as well as other functions for 5GC 190. IP Services 196 may include, for example, the Internet, an intranet, an IMS, a PS streaming service, and/or other IP services.

In various aspects, a network entity or network node can be implemented as an aggregated base station, a disaggregated base station, a component of a base station, an integrated access and backhaul (IAB) node, a relay node, a sidelink node, a transmission reception point (TRP), or a combination thereof, to name a few examples.

As indicated above, FIG. 1 is provided as an example. Other examples may differ from what is described with regard to FIG. 1.

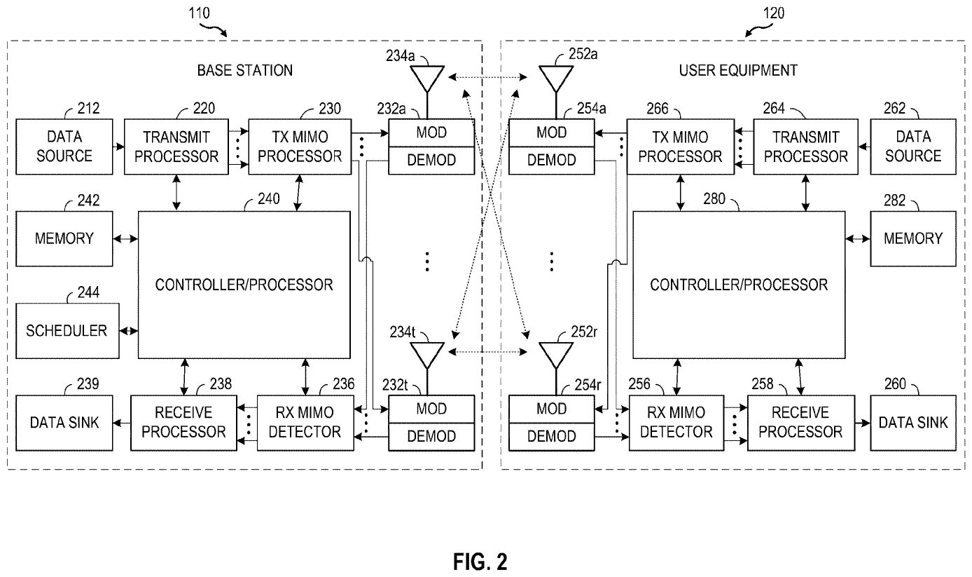

FIG. 2 depicts aspects of an example BS 110 and UE 120, in accordance with the present disclosure.

Generally, BS 110 includes various processors (e.g., 220, 230, 238, and 240), antennas 234a-t (collectively 234), transceivers 232a-t (collectively 232), which include modulators and demodulators, and other aspects, which enable wireless transmission of data (e.g., data source 212) and wireless reception of data (e.g., data sink 239). For example, BS 110 may send and receive data between BS 110 and UE 120. BS 110 includes controller/processor 240, which may be configured to implement various functions described herein related to wireless communications.

Generally, UE 120 includes various processors (e.g., 258, 264, 266, and 280), antennas 252a-r (collectively 252), transceivers 254a-r (collectively 254), which include modulators and demodulators, and other aspects, which enable wireless transmission of data (e.g., retrieved from data source 262) and wireless reception of data (e.g., provided to data sink 260). UE 120 includes controller/processor 280, which may be configured to implement various functions described herein related to wireless communications.

For an example downlink transmission, BS 110 includes a transmit processor 220 that may receive data from a data source 212 and control information from a controller/processor 240. The control information may be for the physical broadcast channel (PBCH), the physical control format indicator channel (PCFICH), the physical hybrid automatic repeat request (HARQ) indicator channel (PHICH), the physical downlink control channel (PDCCH), the group common PDCCH (GC PDCCH), and/or other channels. The data may be for the physical downlink shared channel (PDSCH), in some examples.

Transmit processor 220 may process (e.g., encode and symbol map) the data and control information to obtain data symbols and control symbols, respectively. Transmit processor 220 may also generate reference symbols, such as for the primary synchronization signal (PSS), the secondary synchronization signal (SSS), the PBCH demodulation reference signal (DMRS), or the channel state information reference signal (CSI-RS).

Transmit (TX) multiple-input multiple-output (MIMO) processor 230 may perform spatial processing (e.g., precoding) on the data symbols, the control symbols, and/or the reference symbols, if applicable, and may provide output symbol streams to the modulators (MODs) in transceivers 232a-232t. Each modulator in transceivers 232a-232t may process a respective output symbol stream to obtain an output sample stream. Each modulator may further process (e.g., convert to analog, amplify, filter, and upconvert) the output sample stream to obtain a downlink signal. Downlink signals from the modulators in transceivers 232a-232t may be transmitted via the antennas 234a-234t, respectively.

UE 120 includes antennas 252a-252r that may receive the downlink signals from the BS 110 and may provide received signals to the demodulators (DEMODs) in transceivers 254a-254r, respectively. Each demodulator in transceivers 254a-254r may condition (e.g., filter, amplify, downconvert, and digitize) a respective received signal to obtain input samples. Each demodulator may further process the input samples to obtain received symbols.

MIMO detector 256 may obtain received symbols from all the demodulators in transceivers 254a-254r, perform MIMO detection on the received symbols if applicable, and provide detected symbols. Receive processor 258 may process (e.g., demodulate, deinterleave, and decode) the detected symbols, provide decoded data for the UE 120 to a data sink 260, and provide decoded control information to a controller/processor 280.

For an example uplink transmission, UE 120 further includes a transmit processor 264 that may receive and process data (e.g., for the physical uplink shared channel (PUSCH)) from a data source 262 and control information (e.g., for the physical uplink control channel (PUCCH)) from the controller/processor 280. Transmit processor 264 may also generate reference symbols for a reference signal (e.g., for the sounding reference signal (SRS)). The symbols from the transmit processor 264 may be precoded by a TX MIMO processor 266 if applicable, further processed by the modulators in transceivers 254a-254r (e.g., for SC-FDM), and transmitted to BS 110.

At BS 110, the uplink signals from UE 120 may be received by antennas 234a-234t, processed by the demodulators in transceivers 232a-232t, detected by a MIMO detector 236 if applicable, and further processed by a receive processor 238 to obtain decoded data and control information sent by UE 120. Receive processor 238 may provide the decoded data to a data sink 239 and the decoded control information to the controller/processor 240. Memories 242 and 282 may store data and program codes (e.g., processor-executable instructions, computer-executable instructions) for BS 110 and UE 120, respectively. Scheduler 244 may schedule UEs for data transmission on the downlink and/or uplink.

In various aspects, BS 110 may be described as transmitting and receiving various types of data associated with the methods described herein. In these contexts, “transmitting” may refer to various mechanisms of outputting data, such as outputting data from data source 212, scheduler 244, memory 242, transmit processor 220, controller/processor 240, TX MIMO processor 230, transceivers 232a-t, antenna 234a-t, and/or other aspects described herein. Similarly, “receiving” may refer to various mechanisms of obtaining data, such as obtaining data from antennas 234a-t, transceivers 232a-t, RX MIMO detector 236, controller/processor 240, receive processor 238, scheduler 244, memory 242, a network interface, and/or other aspects described herein.

In various aspects, UE 120 may likewise be described as transmitting and receiving various types of data associated with the methods described herein. In these contexts, “transmitting” may refer to various mechanisms of outputting data, such as outputting data from data source 262, memory 282, transmit processor 264, controller/processor 280, TX MIMO processor 266, transceivers 254a-t, antenna 252a-t, and/or other aspects described herein. Similarly, “receiving” may refer to various mechanisms of obtaining data, such as obtaining data from antennas 252a-t, transceivers 254a-t, RX MIMO detector 256, controller/processor 280, receive processor 258, memory 282, and/or other aspects described herein.

In some aspects, a processor may be configured to perform various operations, such as those associated with the methods described herein, and transmit (output) data to or receive (obtain) data from another interface that is configured to transmit or receive, respectively, the data.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

FIG. 3 depicts an example disaggregated base station 300 architecture. The disaggregated base station 300 architecture may include one or more central units (CUs) 310 that can communicate directly with a core network 320 via a backhaul link, or indirectly with the core network 320 through one or more disaggregated base station units (such as a Near-Real Time (Near-RT) RAN Intelligent Controller (RIC) 325 via an E2 link, or a Non-Real Time (Non-RT) RIC 315 associated with a Service Management and Orchestration (SMO) Framework 305, or both). A CU 310 may communicate with one or more distributed units (DUs) 330 via respective midhaul links, such as an F1 interface. The DUs 330 may communicate with one or more radio units (RUs) 340 via respective fronthaul links. The RUs 340 may communicate with respective UEs 120 via one or more radio frequency (RF) access links. In some implementations, the UE 120 may be simultaneously served by multiple RUs 340.

Each of the units (e.g., the CUs 310, the DUs 330, the RUs 340, as well as the Near-RT RICs 325, the Non-RT RICs 315 and the SMO Framework 305) may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include RRC, packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (e.g., Central Unit—User Plane (CU-UP)), control plane functionality (e.g., Central Unit—Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over-the-air (OTA) communications with one or more UEs 120. In some implementations, real-time and non-real-time aspects of control and user plane communications with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, artificial intelligence/machine learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via O1) or via creation of RAN management policies (such as A1 policies).

As indicated above, FIG. 3 is provided as an example. Other examples may differ from what is described with regard to FIG. 3.

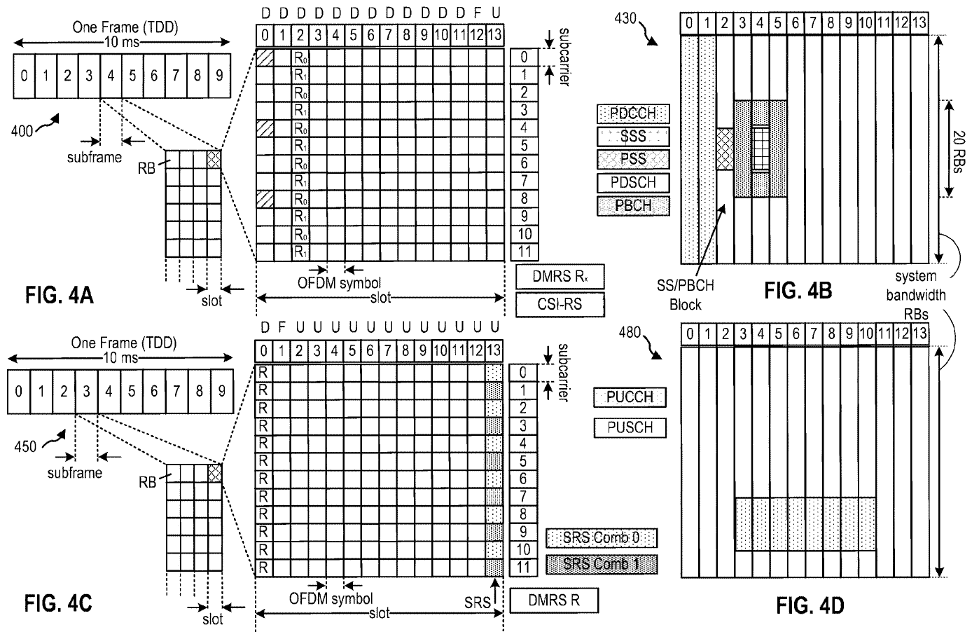

FIGS. 4A, 4B, 4C, and 4D depict aspects of data structures for a wireless communications network, such as wireless communications network 100 of FIG. 1, in accordance with the present disclosure. FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where D is DL, U is UL, and F is flexible for use between DL/UL. UEs may be configured with a slot format through a received slot format indicator (SFI) (dynamically through DL control information (DCI), or semi-statically/statically through RRC signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2^{μ} slots/subframe. The subcarrier spacing and symbol length/duration are a function of the numerology. The subcarrier spacing may be equal to 2^{μ}×15 kHz, where μ is the numerology index, which may be selected from values 0 to 5. Accordingly, the numerology μ=0 has a subcarrier spacing of 15 kHz and the numerology μ=5 has a subcarrier spacing of 480 kHz. Other numerologies and subcarrier spacings may be used. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RSs) for a UE (e.g., UE 120). The RSs may include demodulation RSs (DMRSs) and/or channel state information reference signals (CSI-RSs) for channel estimation at the UE. The RSs may also include beam measurement RSs (BRSs), beam refinement RSs (BRRSs), and/or phase tracking RSs (PT-RSs).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., UE 120) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRSs. The physical broadcast channel (PBCH), which carries a master information block (MIB), may be logically grouped with the PSS and SSS to form a synchronization signal (SS)/PBCH block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRSs (indicated as R for one particular configuration, but other DMRS configurations are possible) for channel estimation at the base station. The UE may transmit DMRSs for the PUCCH and DMRSs for the PUSCH. The PUSCH DMRSs may be transmitted, for example, in the first one or two symbols of the PUSCH. The PUCCH DMRSs may be transmitted in different configurations depending on whether short or long PUCCHs are transmitted and depending on the particular PUCCH format used. UE 120 may transmit sounding reference signals (SRSs). The SRSs may be transmitted, for example, in the last symbol of a subframe. The SRSs may have a comb structure, and a UE may transmit SRSs on one of the combs. The SRSs may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

As indicated above, FIGS. 4A, 4B, 4C, and 4D are provided as examples. Other examples may differ from what is described with regard to FIGS. 4A, 4B, 4C, and 4D.

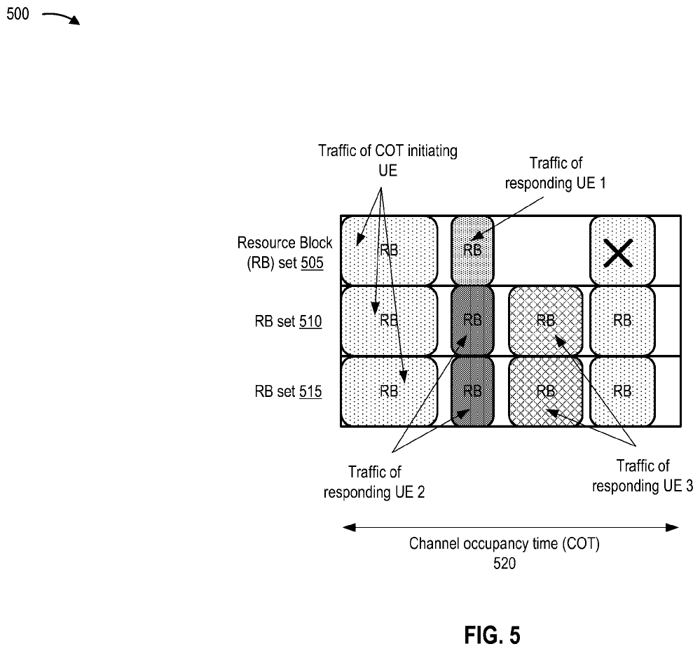

FIG. 5 is a diagram illustrating an example 500 of channel occupancy time resource block sets, in accordance with the present disclosure.

In some cases, when a network node 110 contends for a channel in a 20 MHz unit, the network node 110 may provide a UE 120 with information for a time and frequency domain span of the current channel occupancy. This indication may be included in downlink control information (DCI). For example, this indication may be included in DCI format 2_0, which may be used for a slot format indicator (SFI) or for the COT-SI. For a frequency domain COT, a bitmap may be used to indicate the available bandwidths, such as listen-before-talk (LBT) bandwidths. The indication of available LBT bandwidths may be valid until an end of the COT. For a time domain COT, a COT duration bit-field may be used, per serving cell, to indicate a remaining length from a beginning of a slot where the information is received. The interpretation of the bit-field may be configurable via RRC information. If the bit-field is not present (by configuration), the UE 120 may use an SFI indication (if available) to determine an end of the COT. For example, the UE 120 may assume that the duration of the COT is the same as the duration for which SFI is provided in DCI format 2_0. When the UE 120 receives a COT duration indication with a given symbol that is within the COT duration, the UE 120 may not be expected to receive a subsequent COT duration indication that indicates that the symbol is not to be within the COT duration.

In some cases, an LBT type, a length of a cyclic prefix (CP) extension, and a channel access priority class (CAPC) may be jointly encoded in an uplink grant. The LBT type may be indicated, for example, as shown in Table 1, where CAT is an LBT category and the LBT type is measured in microseconds (μs).

TABLE 1
LBT Type

CAT1 1 μs
CAT2 16 μs
CAT2 25 μs
CAT4

The length of the CP extension may be indicated, for example, as shown in Table 2:

TABLE 2
CP Extension

0 (e.g., no CP extension)
C1 * symbol length - 25 μs
C2 * symbol length - 16 μs - timing advance (TA)
C3 * symbol length - 25 μs - TA

The CAPC may be indicated, for example, as shown in Table 3:

TABLE 3
CAPC

1
2
3
4

The combinations of LBT type, length of CP extension, and CAPC can be dynamically signaled and may be RRC configured for the UE 120 using UE-specific RRC signaling. An RRC configuration may support an indication of all combinations of the LBT type, length of CP extension, and CAPC, with the exception of the excluded combinations shown in Table 4 which may have gap length and LBT type conflicts:

TABLE 4
Excluded Combinations

combination of “C2 * symbol length - 16 us - TA” and “Cat2 25 μs”
combination of “C3 * symbol length - 25 us - TA” and “Cat1 16 μs”
combination of “C3*symbol length - 25 us - TA” and “Cat2 16 μs”
combination of “C1*symbol length - 25 us” and “Cat1 16 μs” or
“Cat2 16 μs”

The bit-field in the DCI may have up to six bits, for example, depending on how many combinations the RRC signaling indicates for the UE 120.

For UE-to-UE (U2U) COT sharing (at least for COT-initiated physical sidelink control channel (PSCCH) and physical sidelink shared channel (PSSCH) transmissions from a COT initiating UE), a responding sidelink (SL) UE may utilize a COT that is shared by the COT initiating UE when the responding SL UE is a target receiver of the COT initiating UE's transmission in the COT. The responding UE may use the shared COT for a transmission when the transmission has an equal or smaller CAPC value than the CAPC value that is indicated in the shared COT information. The destination UE of the COT initiating PSSCH data transmission may be a target receiver UE. The UEs may be indicated by identifiers other than the identifiers that are indicated in the SCI intended for the PSSCH data reception. In some cases, when performing PSSCH/PSCCH transmissions, a responding UE can utilize a COT that is shared by a COT initiating UE, at least when the responding UE's PSSCH/PSCCH transmission within one or more resource block (RB) sets of the shared COT is intended for the COT initiating UE.

A COT initiating UE may initiate a COT 520 across multiple RB sets. The COT initiating UE may share the COT 520 with one or more responding UEs, and the one or more responding UEs may occupy a portion of the RB sets within the COT 520. As shown in the example of FIG. 5, a COT initiating UE may occupy a first resource within RB set 505, a first resource within RB set 510, and a first resource within RB set 515. A responding UE 1 may occupy a second resource within RB set 505, a responding UE 2 may occupy a second resource within RB set 510 and a second resource within RB set 515, and a responding UE 3 may occupy a third resource within RB set 510 and a third resource within RB set 515. In some cases, the COT initiating UE may determine to resume transmissions in the shared COT 520. However, the COT initiating UE may not be able to determine which RB sets the COT initiating UE is allowed to use when resuming the transmissions. For example, the COT initiating UE may not be able to perform a transmission using a fourth resource within RB set 505 since the third resource within RB set 505 is not occupied by the COT initiating UE or any of the responding UEs. This may result in missed transmission opportunities within the shared COT 520 and/or may result in transmission collisions within the shared COT 520 by the COT initiating UE and the responding UEs.

Techniques and apparatuses are described herein for COT sharing. A COT initiating UE may transmit a COT sharing indication to one or more responding UEs that indicates a plurality of RB sets associated with the shared COT. The one or more responding UEs may perform transmissions within the one or more RB sets associated with the shared COT based at least in part on the COT sharing indication. In some aspects, the COT initiating UE may determine to transmit within one or more RB sets of the shared COT using a wideband and based at least in part on a COT sharing condition. In one example, the COT sharing condition may indicate that the COT initiating UE is not to transmit within any of the RB sets of the shared COT. In another example, the COT sharing condition may indicate that the COT initiating UE is allowed to transmit within the RB sets of the shared COT based at least in part on a COT sharing condition. The COT sharing condition may indicate, for example, that the COT initiating UE can transmit within the one or more RB sets of the shared COT if the responding UEs occupy all resources (and/or the one or more RB sets) within the wideband. In some aspects, the COT initiating UE may transmit COT-SI, in an RB set of the plurality of RB sets, that indicates resource allocation information for the RB set. In one example, an RRC message may be used to configure the time and frequency resources for the COT-SI. In another example, the COT-SI may be transmitted by the COT initiating UE using sidelink control information (SCI), such as second stage SCI (SCI-2).

The techniques and apparatuses described herein may enable the COT initiating UE to determine which RB sets the COT initiating UE can use for resuming transmissions within the shared COT. This may reduce missed transmission opportunities within the shared COT and may reduce transmission collisions within the shared COT. In the example where the COT sharing indication indicates that the COT initiating UE is not to transmit within any of the RB sets of the shared COT, overlapping transmissions between the COT initiating UE and the responding UEs within the shared COT may be reduced or eliminated. In the example where the COT sharing indication indicates that the COT initiating UE can transmit within the RB sets of the shared COT based at least in part on a COT sharing condition, the COT initiating UE may be able to resume transmissions within the shared COT if the COT sharing condition is satisfied, thereby reducing a likelihood of missed transmission opportunities within the shared COT. In some examples, the COT initiating UE may transmit COT-SI that explicitly indicates which RB sets within the COT are able to be used for transmissions by respective UEs. This may enable the COT initiating UE and the responding UE to share the COT while reducing or eliminating overlapping transmissions and wasted resources. Additional details are described herein.

As indicated above, FIG. 5 is provided as an example. Other examples may differ from what is described with regard to FIG. 5.

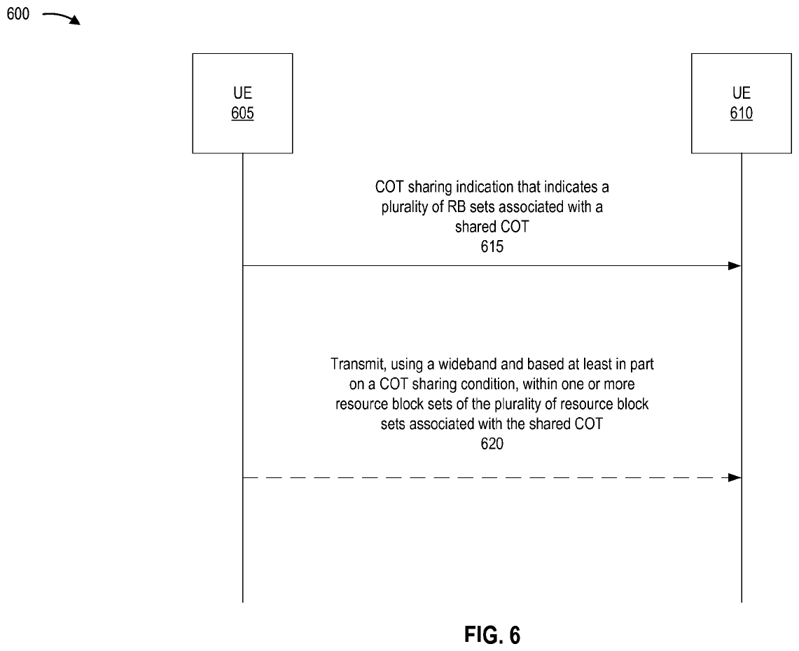

FIG. 6 is a diagram illustrating an example 600 of COT sharing, in accordance with the present disclosure. A UE 605 may communicate with a UE 610. The UE 605 may be, for example, a COT initiating UE, and the UE 610 may be, for example, a responding UE. In some aspects, the COT initiating UE 605 may share a COT with a plurality of responding UEs 610.

As shown by reference number 615, the UE 605 may transmit, and the UE 610 may receive, a COT sharing indication that indicates a plurality of RB sets associated with a shared COT. The UE 610 (or multiple UEs 610) may occupy one or more RB sets within the shared COT and may perform transmissions within the shared COT using the occupied RB sets.

As shown by reference number 620, the UE 605 may selectively transmit, using a wideband and based at least in part on a COT sharing condition, within one or more RB sets of the plurality of RB sets associated with the shared COT. For example, the UE 605 may resume transmissions within the one or more RB sets of the shared COT using the wideband based at least in part on the COT sharing condition being satisfied.

In a first example, the COT sharing condition indicates that if the UE 605 shares the COT with any eligible responding UE, such as the UE 610, the UE 605 is not allowed to resume transmissions within the shared COT. In this example, selectively transmitting within the one or more RB sets of the shared COT based at least in part on the COT sharing condition may include determining not to transmit within the one or more RB sets of the shared COT.

In a second example, the COT sharing condition indicates that if the UE 605 shares the COT with any eligible responding UE, such as the UE 610, the UE 605 is allowed to resume transmissions in the shared COT. The UE 605 may need to ensure that all RB sets within the COT are shared by the eligible responding UEs.

In some aspects, the UE 605 may only share the COT if the UE 610 can occupy the wideband. For example, the UE 605 may share the COT based at least in part on a reservation by the UE 610 indicating that the UE 610 can share the wideband.

In some aspects, the UE 605 may only share the COT if the UE 610 can fill the entire wideband to maintain the COT. This may reduce collisions, for example, if more than one responding UE shares the COT at the same time. In some aspects, a CP extension may be used for resource collision avoidance. In one example, each additional ID (associated, respectively, with each responding UE) may have one bit to indicate whether the CP extension is needed. In another example, the UE 605 may determine whether the CP extension is needed based at least in part on a threshold. For example, traffic may be separated into two priority levels, and the traffic associated with a higher priority level may make the gap 16 μs by using CP extension. In another example, the UE 605 may dynamically indicate the threshold that indicates whether the CP extension is needed.

In some aspects, the UE 605 may dynamically indicate whether the UE 610 needs to fill the whole wideband. In this example, each additional ID (associated, respectively, with each responding UE) may have one bit to indicate whether the UE needs to fill the whole wideband.

In some aspects, a resource within the shared COT may be preempted. The UE 610 may indicate the preempted resource and the UE ID associated with the UE may preempt the resource, and the UE 605 may not perform a transmission using the preempted resource. In one example, if the UE 610 is not able to use the resource and UE 605 wants to resume the resource in the RB set, the UE 605 may need to fill the resources to make sure the UE 605 can resume the transmission later. If the UE that preempts the resource is not eligible to share the resource, but the UE that preempts the resource fails to contend the channel, the UE may still be able to resume the resource. In some aspects, the resource may not be able to be used. The UE 610 may transmit an indication of the resource that is not able to be used, and the UE 605 may not perform a transmission in the resource that is not able to be used. In one example, if the UE 610 is not able to use the resource and the UE 605 wants to resume the resource in this RB set, the UE 605 may need to fill the resources to make sure it can resume the transmission later.

In a third example, the COT sharing condition may indicate that if the UE 605 shares the COT with any eligible responding UE, such as the UE 610, the UE 605 may monitor the COT sharing and determine which RB sets within the COT that the UE 605 can use for resuming transmissions within the COT. In this example, the UE 605 may monitor SCI for each RB set and for each slot in the shared COT.

While the examples described above are associated with a COT that includes multiple RB sets, in some aspects, the COT may include only a single RB set that is shared by the UE 605 and one or more responding UEs, such as the UE 610.

As indicated above, FIG. 6 is provided as an example. Other examples may differ from what is described with regard to FIG. 6.

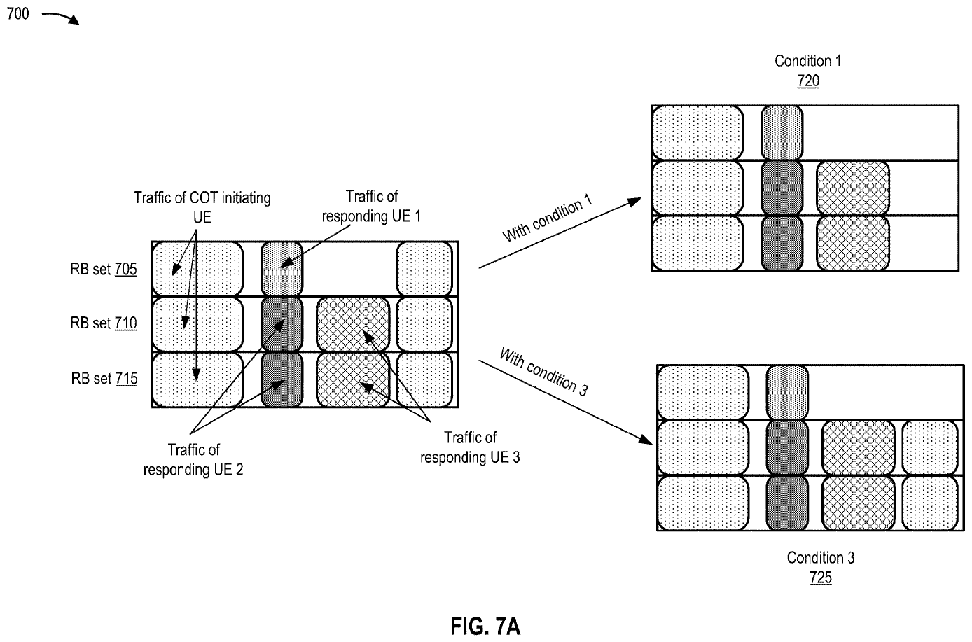

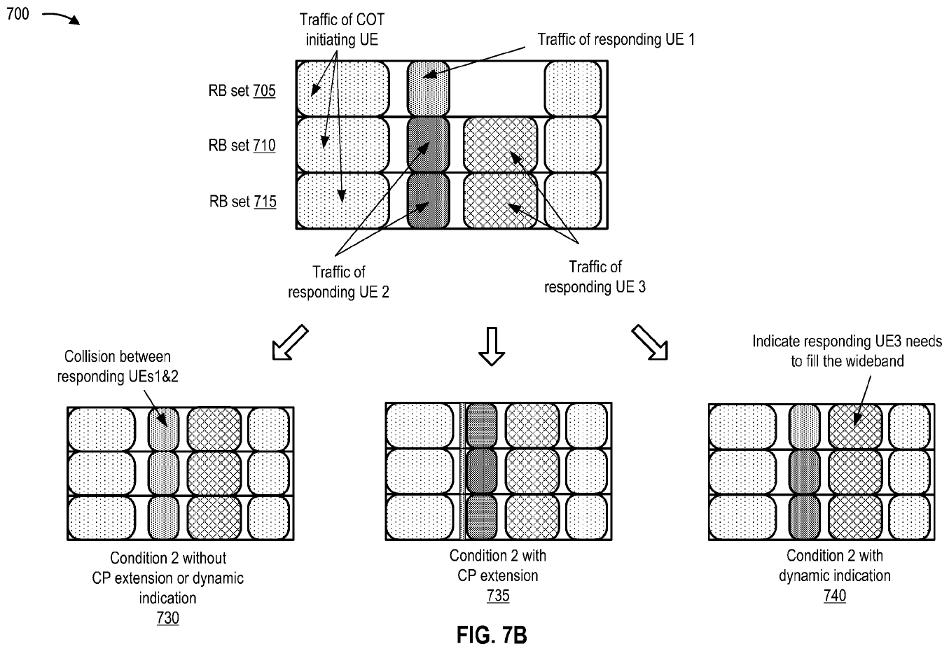

FIGS. 7A-7B are diagrams illustrating examples 700 of RB sets for COT sharing, in accordance with the present disclosure. A COT initiating UE, a responding UE 1, a responding UE 2, and a responding UE 3 may be configured to perform transmissions within one or more RB sets associated with a shared COT. The COT initiating UE may be, for example, the UE 605, and one or more of the responding UEs may be, for example, the UE 610. The one or more RB sets associated with the shared COT may include RB set 705, RB set 710, and RB set 715.

In some aspects, as described in the first example of FIG. 6, a COT sharing condition (condition 1) may indicate that if the COT initiating UE shares the COT with any eligible responding UE, the COT initiating UE is not allowed to resume transmissions within the shared COT. As shown by reference number 720, the COT initiating UE may not resume transmissions within the COT after the initial transmissions performed in the first resource of RB set 705, the first resource of RB set 710, and the first resource of RB set 715.

In some aspects, as described in the third example of FIG. 6, a COT sharing condition (condition 3) may indicate that if the COT initiating UE shares the COT with any eligible responding UE, the COT initiating UE may monitor the COT sharing and determine which RB sets the COT initiating UE can use for resuming transmissions within the COT. As shown in FIG. 7A by reference number 725, the COT initiating UE may resume transmissions using the fourth resource of RB set 710 and the fourth resource of RB set 715, for example, since the third resource of RB set 710 and the third resource of RB set 715 are occupied by the responding UE 3.

In some aspects, as described in the second example of FIG. 6, a COT sharing condition (condition 2) may indicate that if the COT initiating UE shares the COT with any eligible responding UE, the COT initiating UE is allowed to resume transmissions in the shared COT. The COT initiating UE may need to ensure that all RB sets within the COT are shared by the eligible responding UEs. In some aspects, as shown in FIG. 7B by reference number 730, the COT initiating UE may not add a CP extension to the shared COT and may not dynamically indicate that the responding UEs need to fill the whole wideband. This may result in a collision between responding UE 1 and responding UE 2. In some aspects, as shown by reference number 735, the COT initiating UE may add a CP extension to the COT. This may avoid the resource collision, for example, between responding UE 1 and responding UE 2, and may allow the COT initiating UE to resume transmissions in each of the RB sets. In some aspects, as shown by reference number 740, the COT initiating UE may dynamically indicate that the responding Ues need to fill the whole wideband. For example, the COT initiating UE may indicate that responding UE 3 needs to fill the wideband. This may enable the COT initiating UE to resume transmissions in each of the RB sets.

As indicated above, FIGS. 7A-7B are provided as examples. Other examples may differ from what is described with regard to FIGS. 7A-7B.

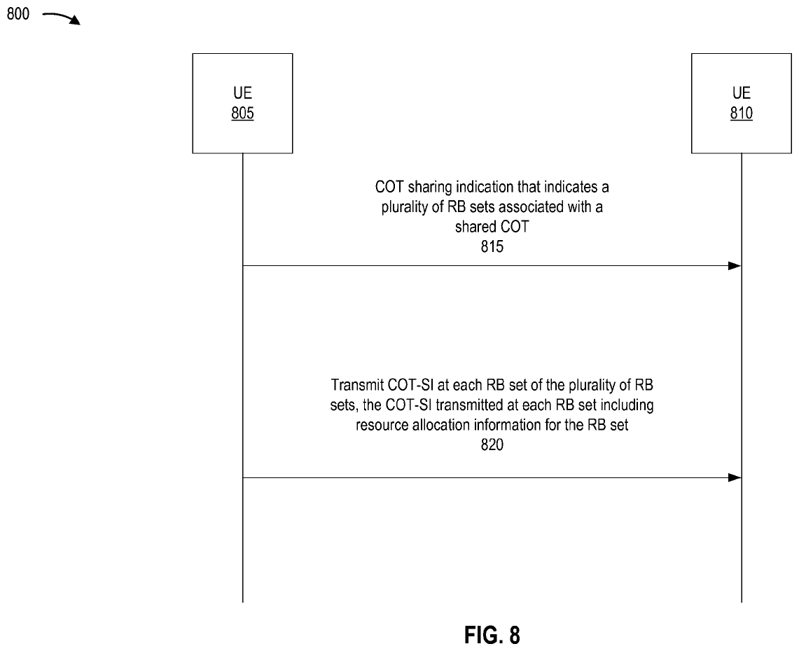

FIG. 8 is a diagram illustrating an example 800 of COT sharing, in accordance with the present disclosure. A UE 805 may communicate with a UE 810. The UE 805 may be, for example, a COT initiating UE, and the UE 810 may be, for example, a responding UE. In some aspects, the COT initiating UE 805 share a COT with a plurality of responding Ues 810.

As shown by reference number 815, the UE 805 may transmit, and the UE 810 may receive, a COT sharing indication that indicates a plurality of RB sets associated with a shared COT. The UE 810 (or multiple Ues 810) may occupy one or more RB sets within the shared COT and may perform transmissions within the shared COT using the occupied RB sets.

As shown by reference number 820, the UE 805 may transmit COT-SI at one or more RB set of the plurality of RB sets. For example, the UE 805 may transmit COT-SI at each RB set of the plurality of RB sets. The COT-SI transmitted at each RB set may include resource allocation information associated with the respective RB set. In some aspects, transmitting the COT-SI may include transmitting SCI that includes the COT-SI.

In some aspects, the UE 805 may receive RRC information that configures time and frequency resources for transmitting the COT-SI. For an RB set that does not include a PSCCH, the UE 805 may receive an indication of a number of symbols in a resource pool, starting from a second symbol that is available for SL transmissions in a slot, and a number of PRBs in the resource pool, starting from the lowest PRB of the lowest sub-channel in the RB set. The number of symbols in the resource pool may be indicated by sl-TimeResourceCOTSI and the number of PRBs in the resource pool may be indicated by sl-FreqResourceCOTSI. For an RB set that includes a PSCCH, the UE 805 may receive an indication of a number of symbols in a resource pool and a number of PRBs in the resource pool. The number of symbols in the resource pool may be indicated by sl-TimeResourceCOTSI, and the number of PRBs in the resource pool may be indicated by sl-FreqResourceCOTSI. In one example, the starting symbol may be the second symbol that is available for SL transmissions in the slot, and the starting RB may be the RB that is immediately after the PSCCH. In another example, the starting symbol may be the symbol that is immediately after the PSCCH, and the starting RB may be the lowest PRB of the lowest sub-channel in the RB set. A modulation and coding scheme (MCS) for the COT-SI may be the same as the MCS for the PSCCH.

In some aspects, the COT-SI may be associated with a mapping rule. For an RB set that does not include SCI-2, the COT-SI may be mapped in increasing order of the frequency index within the associated RB set and then the time index, starting at the first PSSCH symbol carrying an associated DMRS. For an RB set that includes SCI-2, the COT-SI may be transmitted immediately after the SCI-2. The MCS for the COT-SI may be the same as the MCS for the SCI-2.

In some aspects, the UE 805 may transmit a single COT-SI for a wideband operation. Additionally, the UE 805 may transmit a detailed sharable resource. In one example, the detailed sharable resource may be a bitmap that indicates which RB sets are available to be shared. In another example, the sharable RB sets may be indicated per ID, where each ID is associated with a respective responding UE. In another example, time and frequency resources may be indicated per ID, where each ID is associated with a respective responding UE. In some aspects, transmitting the COT-SI may include transmitting first stage SCI (SCI-1) or SCI-2 that includes the COT-SI. The SCI-2 may be a new format SCI-2 that includes legacy content of SCI-2 and the COT-SI.

As indicated above, FIG. 8 is provided as an example. Other examples may differ from what is described with regard to FIG. 8.

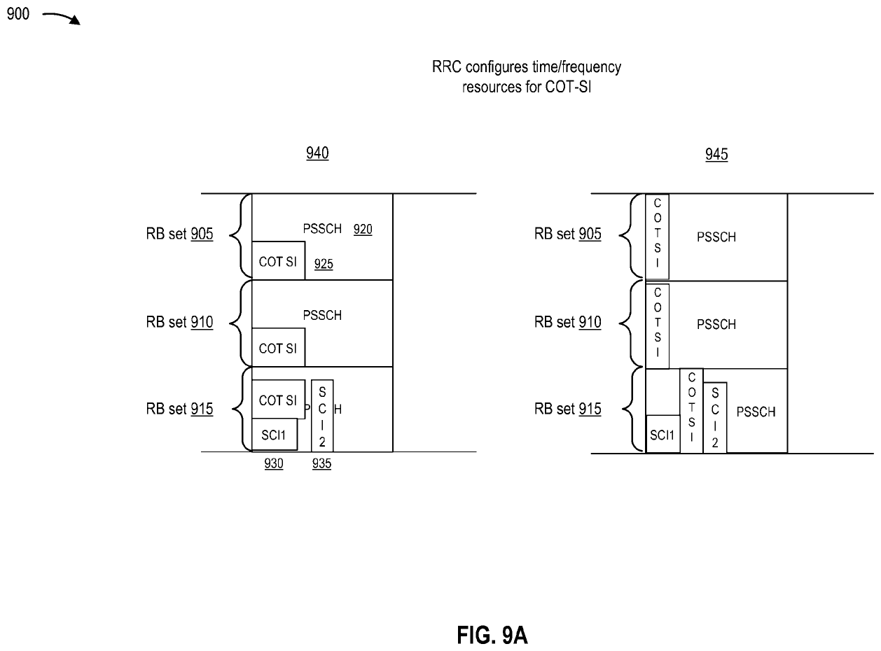

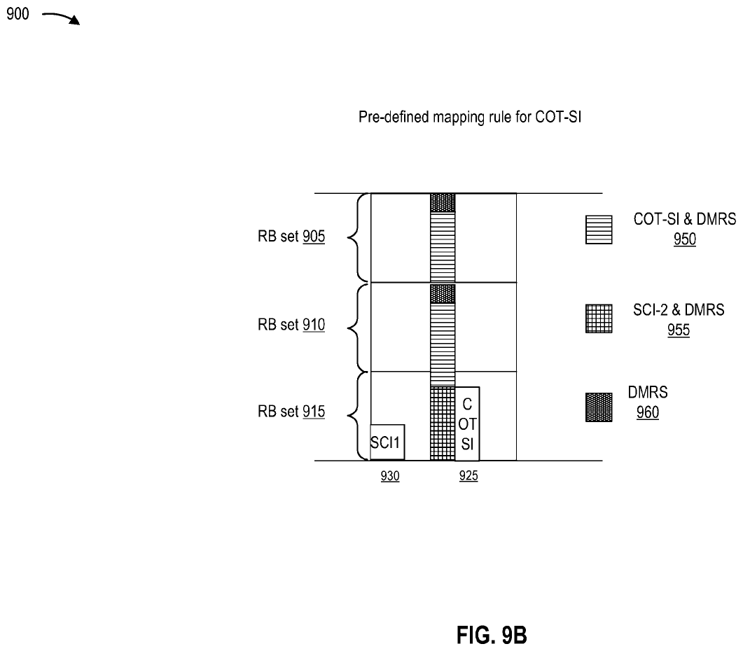

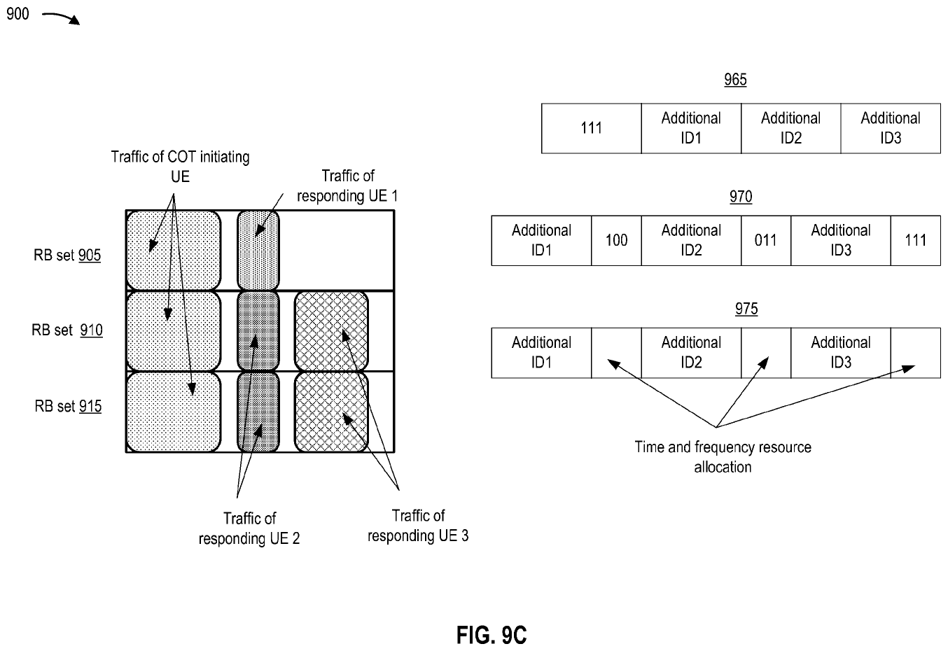

FIGS. 9A-9C are diagrams illustrating examples 900 of RB sets for COT sharing, in accordance with the present disclosure. A COT initiating UE, a responding UE 1, a responding UE 2, and a responding UE 3 may be configured to perform transmissions within one or more RB sets associated with a shared COT. The COT initiating UE may be, for example, the UE 805, and one or more of the responding UEs may be, for example, the UE 810. The one or more RB sets associated with the shared COT may include RB set 905, RB set 910, and RB set 915.

As shown in FIG. 9A, the COT initiating UE may receive RRC information that configures time and frequency resources for transmitting the COT-SI. The RRC information may be received, for example, using SCI-2. In some aspects, the COT initiating UE may receive the SCI-2 that includes the RRC information in a first RB set that includes SCI-1. For example, RB set 905 may include a PSSCH 920 and a COT-SI 925. RB set 910 may include a PSSCH 920 and a COT-SI 925. RB set 915 may include a PSSCH 920, a COT-SI 925, SCI-1 930, and SCI-2 935. In some aspects, as shown by reference number 940, the COT-SI 925 and the SCI-1 930 may be frequency division multiplexed. In some other aspects, as shown by reference number 945, the COT-SI 925 and the SCI-1 930 may be time division multiplexed.

As shown in FIG. 9B, the COT-SI may be associated with a mapping rule. For an RB set that does not include SCI-2, the COT-SI may be mapped in increasing order of the frequency index within the associated RB set and then the time index, starting at the first PSSCH symbol carrying an associated DMRS. For an RB set that includes SCI-2, the COT-SI may be transmitted immediately after the SCI-2. In RB set 905, the COT initiating UE may transmit a DMRS 960 followed by a multiplexed COT-SI and DMRS 950. In RB set 910, the COT initiating UE may transmit a DMRS 960 followed by a multiplexed COT-SI and DMRS 950. In RB set 915, the COT initiating UE may transmit SCI-1 930, followed by a multiplexed COT-SI and DMRS 950, followed by a multiplexed SCI-2 and DMRS 955, followed by a COT-SI 925.

As shown in FIG. 9C, the COT initiating UE may transmit a single COT-SI for a wideband operation. Additionally, the COT initiating UE may transmit a detailed sharable resource. In one example, as shown by reference number 965, the detailed sharable resource may be a bitmap that indicates which RB sets are available to be shared. In another example, as shown by reference number 970, the sharable RB sets may be indicated per ID, where each ID is associated with a respective responding UE. In another example, as shown by reference number 975, time and frequency resources may be indicated per ID, where each ID is associated with a respective responding UE.

As indicated above, FIGS. 9A-9C are provided as examples. Other examples may differ from what is described with regard to FIGS. 9A-9C.

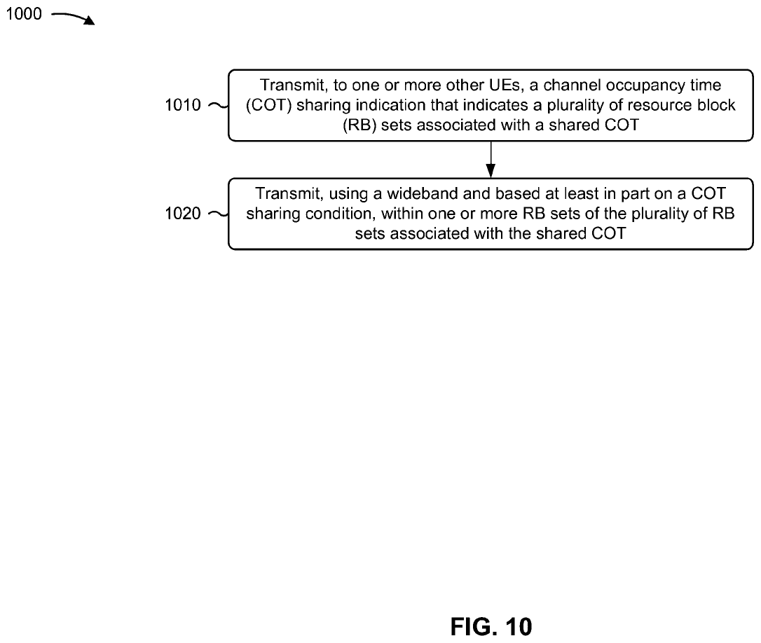

FIG. 10 shows a method 1000 for wireless communications by a UE, such as UE 120.

Method 1000 begins at 1010 with transmitting, to one or more other UEs, a COT sharing indication that indicates a plurality of resource block sets associated with a shared COT.

Method 1000 then proceeds to step 1020 with transmitting, using a wideband and based at least in part on a COT sharing condition, within one or more resource block sets of the plurality of resource block sets associated with the shared COT.

In one aspect, the COT sharing condition indicates that the UE is not to transmit within the plurality of resource block sets associated with the shared COT, wherein the UE determines not to transmit within the one or more resource block sets associated with the shared COT based at least in part on the COT sharing condition.

In one aspect, the COT sharing condition indicates that the UE is configured to transmit within the plurality of resource block sets associated with the shared COT, wherein transmitting within the one or more resource block sets comprises transmitting within the one or more resource block sets associated with the shared COT based at least in part on the COT sharing condition.

In one aspect, transmitting the COT sharing indication comprises transmitting the COT sharing indication based at least in part on the one or more other UEs occupying all resources within the wideband.

In one aspect, transmitting the COT sharing indication further comprises transmitting the COT sharing indication based at least in part on a reservation of a resource block set by the one or more other UEs.

In one aspect, method 1000 further includes maintaining the shared COT based at least in part on the one or more other UEs occupying all resources within the wideband.

In one aspect, the shared COT includes a cyclic prefix extension for resource collision avoidance between the plurality of resource block sets.

In one aspect, each other UE of the one or more other UEs is associated with an identifier that includes a bit that indicates whether the cyclic prefix extension is to be used in the shared COT.

In one aspect, method 1000 further includes determining a cyclic prefix extension threshold that indicates whether the cyclic prefix extension is to be used in the shared COT.

In one aspect, method 1000 further includes transmitting, to the one or more other UEs, an indication of the cyclic prefix extension threshold.

In one aspect, method 1000 further includes transmitting an indication of whether the one or more other UEs are to occupy all resources within the wideband.

In one aspect, each other UE of the one or more other UEs is associated with an identifier that indicates whether the other UE is to occupy all resources within the wideband.

In one aspect, method 1000 further includes receiving, from another UE of the one or more other UEs, an indication of a preempted resource and an identifier of the other UE that occupies the preempted resource.

In one aspect, method 1000 further includes receiving, from another UE of the one or more other UEs, an indication of a preempted resource, wherein the UE is configured not to transmit within the preempted resource.

In one aspect, method 1000 further includes monitoring the shared COT; and identifying, based at least in part on monitoring the shared COT, the one or more resource block sets of the plurality of resource block sets within which the UE is configured to perform transmissions.

In one aspect, monitoring the shared COT comprises monitoring sidelink control information for two or more resource block sets of the plurality of resource block sets.

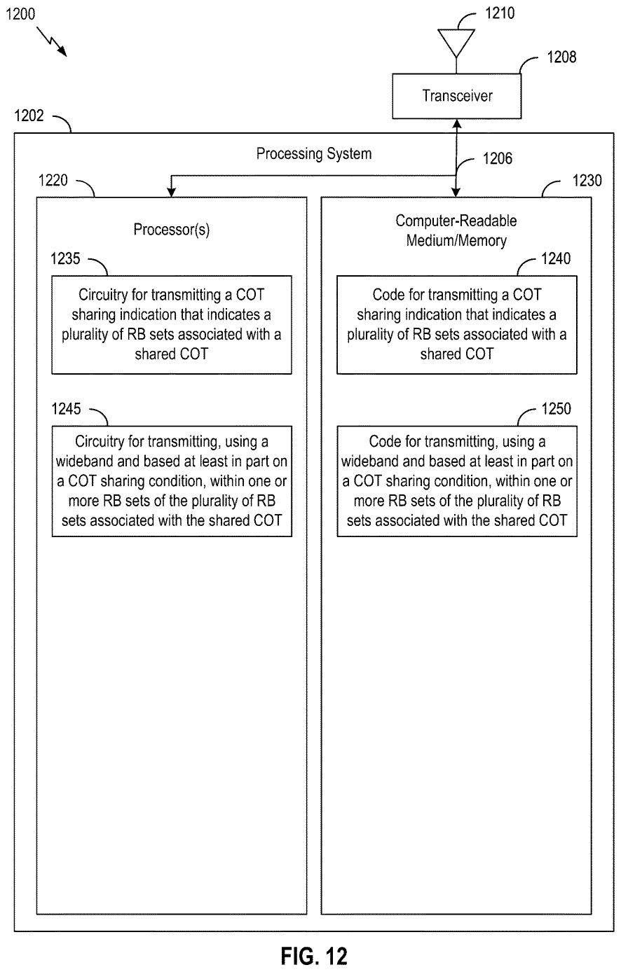

In one aspect, method 1000, or any aspect related to it, may be performed by an apparatus, such as communications device 1200 of FIG. 12, which includes various components operable, configured, or adapted to perform the method 1000. Communications device 1200 is described below in further detail.

Note that FIG. 10 is just one example of a method, and other methods including fewer, additional, or alternative steps are possible consistent with this disclosure.

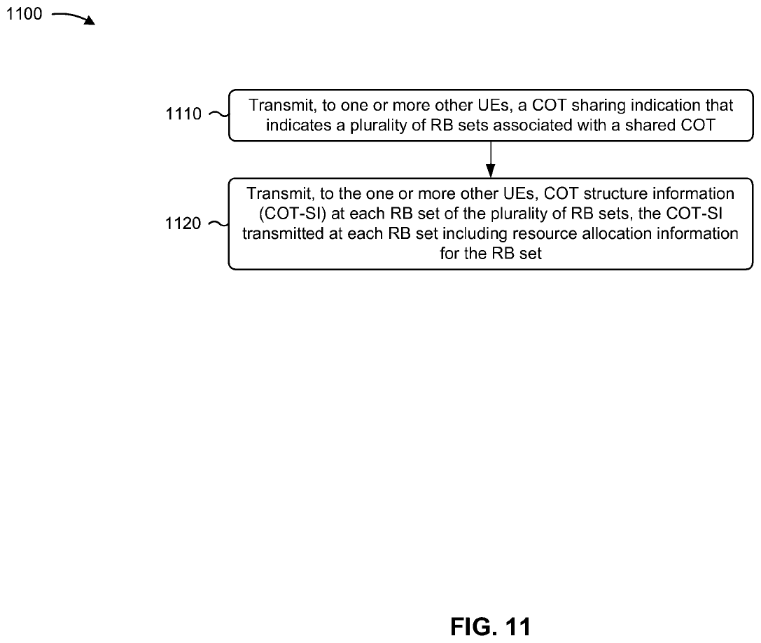

FIG. 11 shows a method 1100 for wireless communications by a UE, such as UE 120.

Method 1100 begins at 1110 with transmitting, to one or more other UEs, a COT sharing indication that indicates a plurality of resource block sets associated with a shared COT.

Method 1100 then proceeds to step 1120 with transmitting, to the one or more other UEs, COT-SI at each resource block set of the plurality of resource block sets, the COT-SI transmitted at each resource block set including resource allocation information for the resource block set.

In one aspect, transmitting the COT-SI comprises transmitting sidelink control information that includes the COT-SI.

In one aspect, method 1100 further includes transmitting radio resource control (RRC) information that configures time and frequency resources for the COT-SI.

In one aspect, transmitting the RRC information comprises transmitting, for a resource block set that does not include a physical sidelink control channel, an indication of a number of symbols in a resource pool starting from a second symbol that is available for sidelink transmissions in a slot, and a number of physical resource blocks in the resource pool starting from a lowest physical resource block of a lowest sub-channel associated with the resource block set.

In one aspect, transmitting the RRC information comprises transmitting, for a resource block set that includes a physical sidelink control channel, an indication of a number of symbols in a resource pool and a number of physical resource blocks within the resource pool.

In one aspect, a starting symbol of the number of symbols in the resource pool is a second symbol that is available for sidelink transmissions in a slot, and a starting resource block is a resource block that is after the physical sidelink control channel.

In one aspect, a starting symbol of the number of symbols in the resource pool is a symbol that is after the physical sidelink control channel, and a starting resource block is a lowest physical resource block of a lowest sub-channel of an associated resource block set.

In one aspect, a modulation coding scheme for the RRC information is the same as a modulation coding scheme for a physical sidelink control channel.

In one aspect, method 1100 further includes determining a mapping for the COT-SI.

In one aspect, determining the mapping comprises mapping, for a resource block set that does not include second stage sidelink control information, the COT-SI in an order that includes a frequency index within the resource block set followed by a time index, wherein the mapping starts at a first physical sidelink shared channel symbol that carries an associated demodulation reference symbol.

In one aspect, transmitting the COT-SI comprises transmitting, for a resource block set that includes second stage sidelink control information, the COT-SI after transmitting the second stage sidelink control information.

In one aspect, a modulation coding scheme for the COT-SI is the same as a modulation coding scheme for second stage sidelink control information.

In one aspect, method 1100 further includes transmitting a single COT-SI for a wideband, wherein a plurality of resource block sets within the wideband share the single COT-SI.

In one aspect, method 1100 further includes transmitting a detailed sharable resource.

In one aspect, transmitting the detailed sharable resource comprises transmitting a bitmap that indicates which resource block sets are available for COT sharing.

In one aspect, transmitting the detailed sharable resource comprises transmitting an indication of sharable resource block sets per identifier, each identifier being associated with another UE of the one or more other UEs.

In one aspect, transmitting the detailed sharable resource comprises transmitting an indication of available time and frequency resources per identifier, each identifier being associated with another UE of the one or more other UEs.

In one aspect, method 1100 further includes indicating the single COT-SI via first stage sidelink control information or second stage sidelink control information.

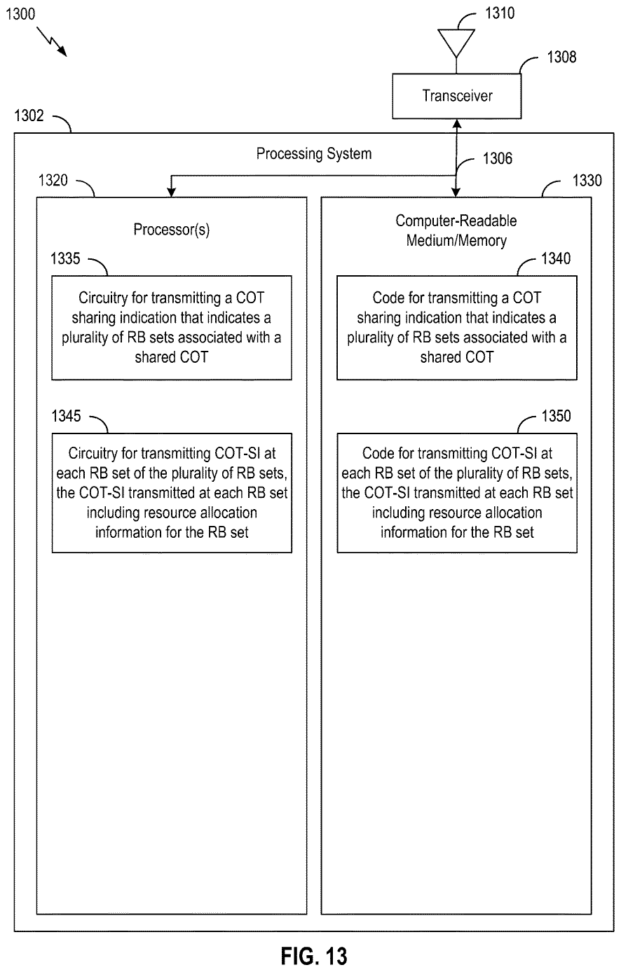

In one aspect, method 1100, or any aspect related to it, may be performed by an apparatus, such as communications device 1300 of FIG. 13, which includes various components operable, configured, or adapted to perform the method 1100. Communications device 1300 is described below in further detail.

Note that FIG. 11 is just one example of a method, and other methods including fewer, additional, or alternative steps are possible consistent with this disclosure.

FIG. 12 is a diagram illustrating an example of an implementation of code and circuitry for a communications device 1200, in accordance with the present disclosure. The communications device 1200 may be a UE, or a UE may include the communications device 1200.

The communications device 1200 includes a processing system 1202 coupled to a transceiver 1208 (e.g., a transmitter and/or a receiver). The transceiver 1208 is configured to transmit and receive signals for the communications device 1200 via an antenna 1210, such as the various signals as described herein. The processing system 1202 may be configured to perform processing functions for the communications device 1200, including processing signals received and/or to be transmitted by the communications device 1200.

The processing system 1202 includes one or more processors 1220. In various aspects, the one or more processors 1220 may be representative of one or more of receive processor 258, transmit processor 264, TX MIMO processor 266, and/or controller/processor 280, as described with respect to FIG. 2. The one or more processors 1220 are coupled to a computer-readable medium/memory 1230 via a bus 1206. In various aspects, the computer-readable medium/memory 1230 may be representative of memory 282, as described with respect to FIG. 2. In certain aspects, the computer-readable medium/memory 1230 is configured to store instructions (e.g., computer-executable code, processor-executable code) that when executed by the one or more processors 1220, cause the one or more processors 1220 to perform the method 1000 described with respect to FIG. 10, or any aspect related to it. Note that reference to a processor performing a function of communications device 1200 may include one or more processors performing that function of communications device 1200.

As shown in FIG. 12, the communications device 1200 may include circuitry for transmitting, to one or more other UEs, a COT sharing indication that indicates a plurality of resource block sets associated with a shared COT (circuitry 1235).

As shown in FIG. 12, the communications device 1200 may include, stored in computer-readable medium/memory 1230, code for transmitting, to one or more other UEs, a COT sharing indication that indicates a plurality of resource block sets associated with a shared COT (code 1240).

As shown in FIG. 12, the communications device 1200 may include circuitry for transmitting, using a wideband and based at least in part on a COT sharing condition, within one or more resource block sets of the plurality of resource block sets associated with the shared COT (circuitry 1245).

As shown in FIG. 12, the communications device 1200 may include, stored in computer-readable medium/memory 1230, code for transmitting, using a wideband and based at least in part on a COT sharing condition, within one or more resource block sets of the plurality of resource block sets associated with the shared COT (code 1250).

Various components of the communications device 1200 may provide means for performing the method 1000 described with respect to FIG. 10, or any aspect related to it. For example, means for transmitting, sending, or outputting for transmission may include the transceiver(s) 254 and/or antenna(s) 252 of the UE 120 and/or transceiver 1208 and antenna 1210 of the communications device 1200 in FIG. 12. Means for receiving or obtaining may include the transceiver(s) 254 and/or antenna(s) 252 of the UE 120 and/or transceiver 1208 and antenna 1210 of the communications device 1200 in FIG. 12.

FIG. 12 is provided as an example. Other examples may differ from what is described in connection with FIG. 12.

FIG. 13 is a diagram illustrating an example of an implementation of code and circuitry for a communications device 1300, in accordance with the present disclosure. The communications device 1300 may be a UE, or a UE may include the communications device 1300.

The communications device 1300 includes a processing system 1302 coupled to a transceiver 1308 (e.g., a transmitter and/or a receiver). The transceiver 1308 is configured to transmit and receive signals for the communications device 1300 via an antenna 1310, such as the various signals as described herein. The processing system 1302 may be configured to perform processing functions for the communications device 1300, including processing signals received and/or to be transmitted by the communications device 1300.

The processing system 1302 includes one or more processors 1320. In various aspects, the one or more processors 1320 may be representative of one or more of receive processor 258, transmit processor 264, TX MIMO processor 266, and/or controller/processor 280, as described with respect to FIG. 2. The one or more processors 1320 are coupled to a computer-readable medium/memory 1330 via a bus 1306. In various aspects, the computer-readable medium/memory 1330 may be representative of memory 282, as described with respect to FIG. 2. In certain aspects, the computer-readable medium/memory 1330 is configured to store instructions (e.g., computer-executable code, processor-executable code) that when executed by the one or more processors 1320, cause the one or more processors 1320 to perform the method 1100 described with respect to FIG. 11, or any aspect related to it. Note that reference to a processor performing a function of communications device 1300 may include one or more processors performing that function of communications device 1300.

As shown in FIG. 13, the communications device 1300 may include circuitry for transmitting, to one or more other UEs, a channel occupancy time (COT) sharing indication that indicates a plurality of resource block sets associated with a shared COT (circuitry 1335).

As shown in FIG. 13, the communications device 1300 may include, stored in computer-readable medium/memory 1330, code for transmitting, to one or more other UEs, a COT sharing indication that indicates a plurality of resource block sets associated with a shared COT (code 1340).

As shown in FIG. 13, the communications device 1300 may include circuitry for transmitting, to the one or more other UEs, COT-SI at each resource block set of the plurality of resource block sets, the COT-SI transmitted at each resource block set including resource allocation information for the resource block set (circuitry 1345).

As shown in FIG. 13, the communications device 1300 may include, stored in computer-readable medium/memory 1330, code for transmitting, to the one or more other UEs, COT-SI at each resource block set of the plurality of resource block sets, the COT-SI transmitted at each resource block set including resource allocation information for the resource block set (code 1350).

Various components of the communications device 1300 may provide means for performing the method 1100 described with respect to FIG. 11, or any aspect related to it. For example, means for transmitting, sending, or outputting for transmission may include the transceiver(s) 254 and/or antenna(s) 252 of the UE 120 and/or transceiver 1308 and antenna 1310 of the communications device 1300 in FIG. 13. Means for receiving or obtaining may include the transceiver(s) 254 and/or antenna(s) 252 of the UE 120 and/or transceiver 1308 and antenna 1310 of the communications device 1300 in FIG. 13.

FIG. 13 is provided as an example. Other examples may differ from what is described in connection with FIG. 13.

The following provides an overview of some Aspects of the present disclosure:

Aspect 1: A method of wireless communication performed by a user equipment (UE), comprising: transmitting, to one or more other UEs, a channel occupancy time (COT) sharing indication that indicates a plurality of resource block sets associated with a shared COT; and transmitting, using a wideband and based at least in part on a COT sharing condition, within one or more resource block sets of the plurality of resource block sets associated with the shared COT.

Aspect 2: The method of Aspect 1, wherein the COT sharing condition indicates that the UE is not to transmit within the plurality of resource block sets associated with the shared COT, and wherein the UE determines not to transmit within the one or more resource block sets associated with the shared COT based at least in part on the COT sharing condition.

Aspect 3: The method of any of Aspects 1-2, wherein the COT sharing condition indicates that the UE is configured to transmit within the plurality of resource block sets associated with the shared COT, and wherein transmitting within the one or more resource block sets comprises transmitting within the one or more resource block sets associated with the shared COT based at least in part on the COT sharing condition.

Aspect 4: The method of Aspect 3, wherein transmitting the COT sharing indication comprises transmitting the COT sharing indication based at least in part on the one or more other UEs occupying all resources within the wideband.

Aspect 5: The method of Aspect 4, wherein transmitting the COT sharing indication further comprises transmitting the COT sharing indication based at least in part on a reservation of a resource block set by the one or more other UEs.

Aspect 6: The method of Aspect 3, further comprising maintaining the shared COT based at least in part on the one or more other UEs occupying all resources within the wideband.

Aspect 7: The method of Aspect 6, wherein the shared COT includes a cyclic prefix extension for resource collision avoidance between the plurality of resource block sets.

Aspect 8: The method of Aspect 7, wherein each other UE of the one or more other UEs is associated with an identifier that includes a bit that indicates whether the cyclic prefix extension is to be used in the shared COT.

Aspect 9: The method of Aspect 7, further comprising determining a cyclic prefix extension threshold that indicates whether the cyclic prefix extension is to be used in the shared COT.

Aspect 10: The method of Aspect 9, further comprising transmitting, to the one or more other UEs, an indication of the cyclic prefix extension threshold.

Aspect 11: The method of Aspect 6, further comprising transmitting an indication of whether the one or more other UEs are to occupy all resources within the wideband.

Aspect 12: The method of Aspect 11, wherein each other UE of the one or more other UEs is associated with an identifier that indicates whether the other UE is to occupy all resources within the wideband.

Aspect 13: The method of Aspect 6, further comprising receiving, from another UE of the one or more other UEs, an indication of a preempted resource and an identifier of the other UE that occupies the preempted resource.

Aspect 14: The method of Aspect 6, further comprising receiving, from another UE of the one or more other UEs, an indication of a preempted resource, wherein the UE is configured not to transmit within the preempted resource.

Aspect 15: The method of any of Aspects 1-14, further comprising: monitoring the shared COT; and identifying, based at least in part on monitoring the shared COT, the one or more resource block sets of the plurality of resource block sets within which the UE is configured to perform transmissions.

Aspect 16: The method of Aspect 15, wherein monitoring the shared COT comprises monitoring sidelink control information for two or more resource block sets of the plurality of resource block sets.

Aspect 17: A method of wireless communication performed by a user equipment (UE), comprising: transmitting, to one or more other UEs, a channel occupancy time (COT) sharing indication that indicates a plurality of resource block sets associated with a shared COT; and transmitting, to the one or more other UEs, COT structure information (COT-SI) at each resource block set of the plurality of resource block sets, the COT-SI transmitted at each resource block set including resource allocation information for the resource block set.

Aspect 18: The method of Aspect 17, wherein transmitting the COT-SI comprises transmitting sidelink control information that includes the COT-SI.

Aspect 19: The method of any of Aspects 17-18, further comprising transmitting radio resource control (RRC) information that configures time and frequency resources for the COT-SI.

Aspect 20: The method of Aspect 19, wherein transmitting the RRC information comprises transmitting, for a resource block set that does not include a physical sidelink control channel, an indication of a number of symbols in a resource pool starting from a second symbol that is available for sidelink transmissions in a slot, and a number of physical resource blocks in the resource pool starting from a lowest physical resource block of a lowest sub-channel associated with the resource block set.

Aspect 21: The method of Aspect 19, wherein transmitting the RRC information comprises transmitting, for a resource block set that includes a physical sidelink control channel, an indication of a number of symbols in a resource pool and a number of physical resource blocks within the resource pool.

Aspect 22: The method of Aspect 21, wherein a starting symbol of the number of symbols in the resource pool is a second symbol that is available for sidelink transmissions in a slot, and a starting resource block is a resource block that is after the physical sidelink control channel.

Aspect 23: The method of Aspect 21, wherein a starting symbol of the number of symbols in the resource pool is a symbol that is after the physical sidelink control channel, and a starting resource block is a lowest physical resource block of a lowest sub-channel of an associated resource block set.

Aspect 24: The method of Aspect 19, wherein a modulation coding scheme for the RRC information is the same as a modulation coding scheme for a physical sidelink control channel.

Aspect 25: The method of any of Aspects 17-24, further comprising determining a mapping for the COT-SI.

Aspect 26: The method of Aspect 25, wherein determining the mapping comprises mapping, for a resource block set that does not include second stage sidelink control information, the COT-SI in an order that includes a frequency index within the resource block set followed by a time index, wherein the mapping starts at a first physical sidelink shared channel symbol that carries an associated demodulation reference symbol.

Aspect 27: The method of Aspect 25, wherein transmitting the COT-SI comprises transmitting, for a resource block set that includes second stage sidelink control information, the COT-SI after transmitting the second stage sidelink control information.

Aspect 28: The method of Aspect 25, wherein a modulation coding scheme for the COT-SI is the same as a modulation coding scheme for second stage sidelink control information.

Aspect 29: The method of any of Aspects 17-28, further comprising transmitting a single COT-SI for a wideband, wherein a plurality of resource block sets within the wideband share the single COT-SI.

Aspect 30: The method of Aspect 29, further comprising transmitting a detailed sharable resource.

Aspect 31: The method of Aspect 30, wherein transmitting the detailed sharable resource comprises transmitting a bitmap that indicates which resource block sets are available for COT sharing.

Aspect 32: The method of Aspect 30, wherein transmitting the detailed sharable resource comprises transmitting an indication of sharable resource block sets per identifier, each identifier being associated with another UE of the one or more other UEs.

Aspect 33: The method of Aspect 30, wherein transmitting the detailed sharable resource comprises transmitting an indication of available time and frequency resources per identifier, each identifier being associated with another UE of the one or more other UEs.

Aspect 34: The method of Aspect 29, further comprising indicating the single COT-SI via first stage sidelink control information or second stage sidelink control information.

Aspect 35: An apparatus for wireless communication at a device, comprising a processor; memory coupled with the processor; and instructions stored in the memory and executable by the processor to cause the apparatus to perform the method of one or more of Aspects 1-34.

Aspect 36: A device for wireless communication, comprising a memory and one or more processors coupled to the memory, the one or more processors configured to perform the method of one or more of Aspects 1-34.

Aspect 37: An apparatus for wireless communication, comprising at least one means for performing the method of one or more of Aspects 1-34.

Aspect 38: A non-transitory computer-readable medium storing code for wireless communication, the code comprising instructions executable by a processor to perform the method of one or more of Aspects 1-34.

Aspect 39: A non-transitory computer-readable medium storing a set of instructions for wireless communication, the set of instructions comprising one or more instructions that, when executed by one or more processors of a device, cause the device to perform the method of one or more of Aspects 1-34.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules, and circuits described in connection with the present disclosure may be implemented or performed with a general purpose processor, a digital signal processor (DSP), an application-specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices (e.g., a combination of a DSP and a microprocessor, a plurality of microprocessors, one or more microprocessors in conjunction with a DSP core, a system on a chip (SoC), or any other such configuration).

As used herein, the term “determining” encompasses a wide variety of actions. For example, “determining” may include calculating, computing, processing, deriving, investigating, looking up (e.g., looking up in a table, a database, or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or a processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A method of wireless communication performed by a user equipment (UE), comprising:
transmitting, to one or more other UEs, a channel occupancy time (COT) sharing indication that indicates a plurality of resource block sets associated with a shared COT; and
transmitting, using a wideband and based at least in part on a COT sharing condition, within one or more resource block sets of the plurality of resource block sets associated with the shared COT.

2. The method of claim 1, wherein the COT sharing condition indicates that the UE is not to transmit within the plurality of resource block sets associated with the shared COT, and wherein the UE determines not to transmit within the one or more resource block sets associated with the shared COT based at least in part on the COT sharing condition.

3. The method of claim 1, wherein the COT sharing condition indicates that the UE is configured to transmit within the plurality of resource block sets associated with the shared COT, and wherein transmitting within the one or more resource block sets comprises transmitting within the one or more resource block sets associated with the shared COT based at least in part on the COT sharing condition.

4. The method of claim 3, wherein transmitting the COT sharing indication comprises transmitting the COT sharing indication based at least in part on the one or more other UEs occupying all resources within the wideband.

5. The method of claim 3, further comprising maintaining the shared COT based at least in part on the one or more other UEs occupying all resources within the wideband.

6. The method of claim 5, wherein the shared COT includes a cyclic prefix extension for resource collision avoidance between the plurality of resource block sets.

7. The method of claim 6, wherein each other UE of the one or more other UEs is associated with an identifier that includes a bit that indicates whether the cyclic prefix extension is to be used in the shared COT.

8. The method of claim 6, further comprising determining a cyclic prefix extension threshold that indicates whether the cyclic prefix extension is to be used in the shared COT.

9. The method of claim 8, further comprising transmitting, to the one or more other UEs, an indication of the cyclic prefix extension threshold.

10. The method of claim 5, further comprising transmitting an indication of whether the one or more other UEs are to occupy all resources within the wideband.

11. The method of claim 10, wherein each other UE of the one or more other UEs is associated with an identifier that indicates whether the other UE is to occupy all resources within the wideband.

12. The method of claim 5, further comprising receiving, from another UE of the one or more other UEs, an indication of a preempted resource, wherein the UE is configured not to transmit within the preempted resource.

13. The method of claim 1, further comprising:
monitoring the shared COT; and
identifying, based at least in part on monitoring the shared COT, the one or more resource block sets of the plurality of resource block sets within which the UE is configured to perform transmissions.

14. The method of claim 13, wherein monitoring the shared COT comprises monitoring sidelink control information for two or more resource block sets of the plurality of resource block sets.

15. A method of wireless communication performed by a user equipment (UE), comprising:
transmitting, to one or more other UEs, a channel occupancy time (COT) sharing indication that indicates a plurality of resource block sets associated with a shared COT; and
transmitting, to the one or more other UEs, COT structure information (COT-SI) at each resource block set of the plurality of resource block sets, the COT-SI transmitted at each resource block set including resource allocation information for the resource block set.

16. The method of claim 15, wherein transmitting the COT-SI comprises transmitting sidelink control information that includes the COT-SI.

17. The method of claim 15, further comprising transmitting radio resource control (RRC) information that configures time and frequency resources for the COT-SI.

18-21. (canceled)

22. The method of claim 15, further comprising determining a mapping for the COT-SI.

23-24. (canceled)

25. The method of claim 15, further comprising transmitting a single COT-SI for a wideband, wherein a plurality of resource block sets within the wideband share the single COT-SI.

26-28. (canceled)

29. An apparatus for wireless communication at a user equipment (UE), comprising:
a memory; and
one or more processors, coupled to the memory, configured to:
transmit, to one or more other UEs, a channel occupancy time (COT) sharing indication that indicates a plurality of resource block sets associated with a shared COT; and
transmit, using a wideband and based at least in part on a COT sharing condition, within one or more resource block sets of the plurality of resource block sets associated with the shared COT.

30. (canceled)
